(19) United States
(12) Patent Application Publication
(10) Pub. No.: US 2010/0224075 A1
(43) Pub. Date: Sep. 9, 2010

(54) COFFEE MACHINES WITH AT LEAST TWO BREWING GROUPS

(75) Inventor: Markus Anliker, Granichen (CH)

Correspondence Address: SUGHRUE MION, PLLC, 2100 PENNSYLVANIA AVENUE, N.W., SUITE 800, WASHINGTON, DC, 20037, US

(73) Assignee: EGRO COFFEE SYSTEMS AG, Niederrohrdorf (CH)

(21) Appl. No.: 12/738,383

(22) PCT Filed: Sep. 3, 2008
(86) PCT No.: PCT/CH2008/000368

§ 371 Date: May 14, 2010

(30) Foreign Application Priority Data
Oct. 16, 2007 (CH) 1604/07

(51) Int. Cl. A47J 31/44; A47J 31/46

(52) U.S. Cl. 99/291

(57) ABSTRACT

The coffee machine (1) according to the invention comprises at least two brewing groups (4, 5) and a hot water device (2, 2′) which supplies the brewing groups (4, 5) with hot water. The brewing groups (4, 5) have a coffee dispenser (11) almost at the same location. Each brewing group (4, 5) is individually actuatable.

The invention refers to a coffee machine with at least two brewing groups according to the preamble of claim 1.

By “brewing group” it is meant a cylinder-piston unit for the brewing of ground coffee with the associated mechanical drive and control elements. Coffee machines with two brewing groups are available in the marketplace. They usually work in a fully automatic way and at the press of a button they produce a pre-selected coffee beverage. In these known coffee machines two parallel brewing groups are provided which are each fed by their own hot water boiler and have their own dispensing outlet for the coffee, so that two cups standing next to each other can be simultaneously filled. In principle it is like having a double coffee machine in one housing. In this way it is certainly possible to prepare and dispense coffee, but other advantages such as space-saving are barely achieved. Publication WO 98/039998 discloses a coffee automat with two brewing chambers of different sizes which are arranged in parallel in a brewing block and which work in parallel, wherein, however, coffee can only be brewed in one chamber at a time. The second brewing chamber is empty during the brewing cycle and during this time it cannot even be prepared for the next coffee preparation. Hence the two brewing chambers can work in parallel but cannot be operated independently of each other.

The object of the present invention is to provide an automatic coffee machine, in particular for use in the catering business, which can produce a large variety of coffee products and qualities and from which large quantities of coffee can be obtained in a short period of time.

This object is achieved by a device with the features of claim 1.

The automatic coffee machine according to the invention comprises at least two brewing groups for producing a coffee beverage, which are independent of one another and can be separately controlled, a device for the preparation and distribution of the coffee powder to the brewing groups as well as a central coffee dispensing outlet, i.e. the coffee dispensing outlets of the two brewing groups end at the same location. Each brewing group has an upstream brewing valve which controls the supply of hot water from the hot water boiler. In this case each brewing group can be allocated its own boiler or the brewing groups can be supplied by one single boiler. For the production of various coffee beverages such as espresso or white coffee and similar beverages it has resulted that the quality of the individual products can be improved by an appropriate brewing group geometry, i.e. by various brewing cylinder diameters and/or brewing cylinder heights. It is in fact advantageous for the preparation of an espresso to use a brewing group having a brewing cylinder with a small diameter of, for example, 37 mm and for a coffee beverage which is prepared with a larger quantity of water to use a brewing cylinder with a larger inner diameter of, for example, 44 mm. The device for supplying and feeding the brewing groups contains several storage containers which hold different sorts of coffee so that, thanks to the possibility of selecting the sort of coffee and the brewing group, a large variety of coffee products and qualities can be produced with the coffee machine according to the invention. The variety can be further extended thanks to further controllable parameters such as water quantity and temperature. In addition, the coffee machine contains an electronic control such that after the selection of a certain coffee product, at the press of a button the desired sort of coffee is selected and the corresponding brewing group is actuated. Since the individual brewing groups work independently of one another it is possible, during the preparation of a coffee in one brewing group, to prepare the next coffee in the other brewing group. In this way the downtime between the dispensing of two consecutive beverages is substantially reduced.

Further advantages of the invention are clear from the dependent claims and from the description below in which the invention is explained in more detail by using exemplary embodiments illustrated in the schematic drawings.

They shows:

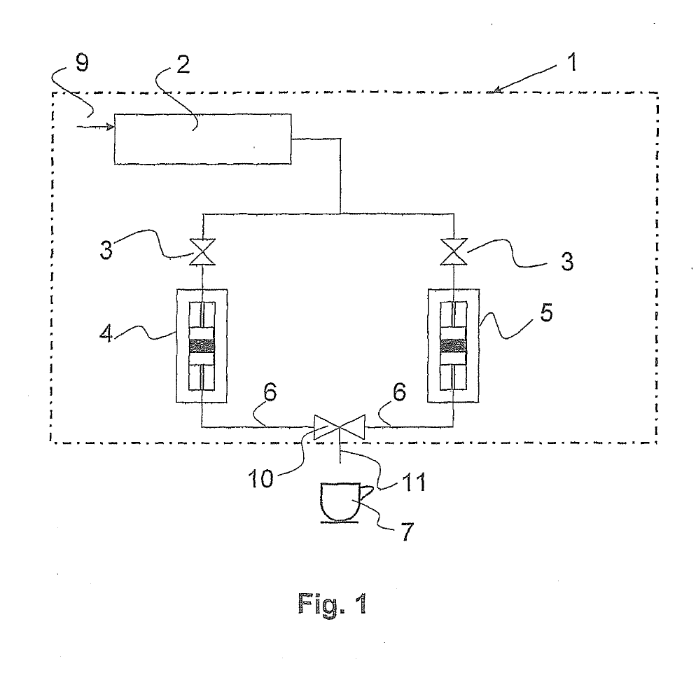

FIG. 1 a scheme of a first embodiment of the coffee machine,

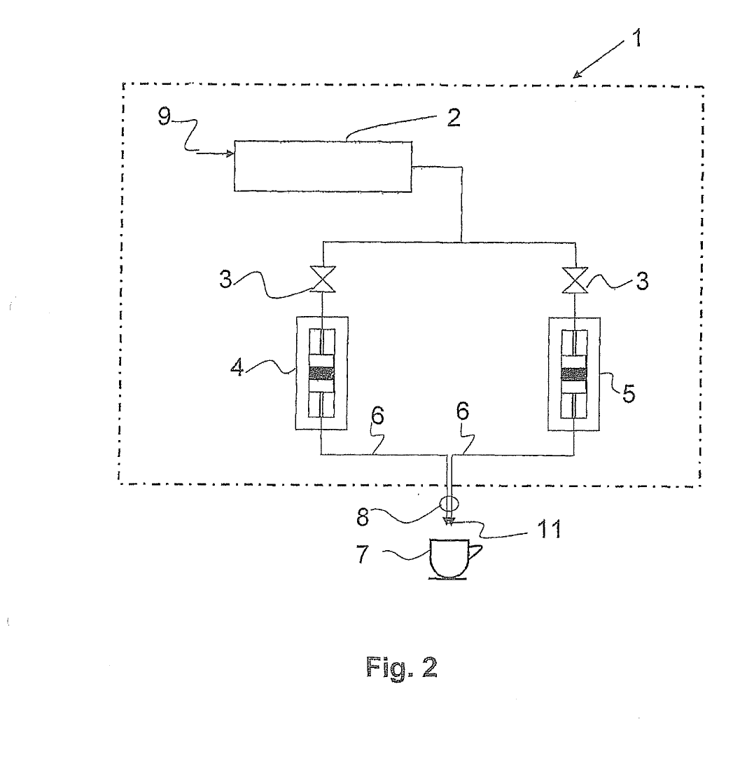

FIG. 2 a scheme of a second embodiment of the coffee machine, and

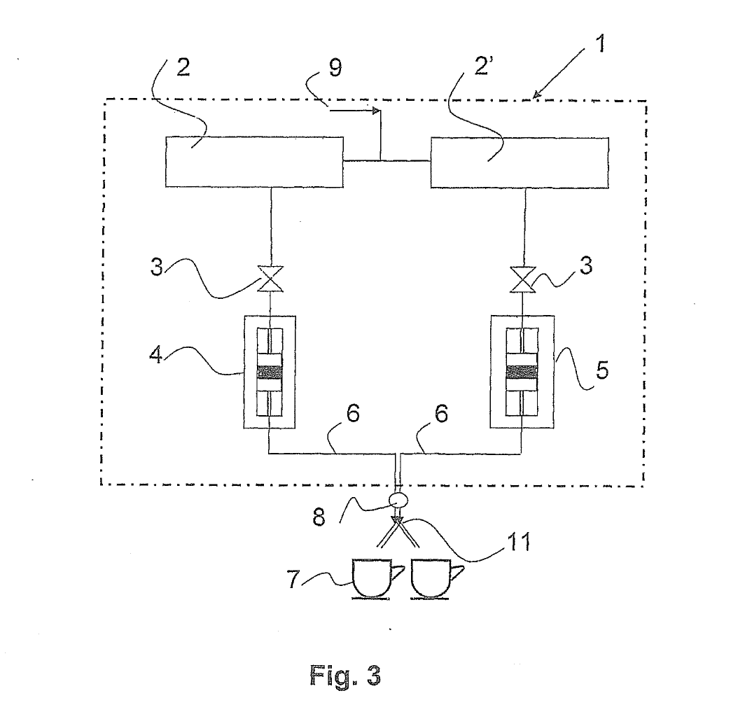

FIG. 3 a scheme of a third embodiment of the coffee machine.

In the figures the same elements have been referred to by the same reference numerals and initial explanations refer to all figures unless otherwise expressly stated.

FIG. 1 shows a scheme for a first embodiment of the coffee machine 1 with a first brewing group 4 and a second brewing group 5. The coffee machine 1 is shown in the drawings with the frame 1 marked by a dash-dotted line. A brewing valve 3 is provided upstream of both brewing groups 4, 5. The brewing groups 4, 5 are supplied, through a forked pipe, with hot water from the common boiler 2 which is supplied with drinking water through a feed pipe 9 and a pump which is not illustrated in the drawings. The coffee dispensing outlets 6 of the first brewing group 4 and of the second brewing group 5 end in a non-return valve 10 which prevents the coffee from returning to the non-operating brewing group. In this way the coffee beverage from the brewing group 4, 5 flows, through the coffee dispensing outlet 6 to the non-return valve 10 and through the coffee dispenser 11 into the coffee cup 7. For the first brewing group 4, for instance, a brewing group can be provided with a brewing cylinder having a small inner diameter and for the second brewing group 5 a brewing cylinder with a larger inner diameter can be provided. The coffee machine 1 can, if the customer desires, be fitted with whichever brewing groups. If the customer intends to use the coffee machine for instance to only make espresso, then the machine 1 can be equipped with two identical brewing groups 4, 5 having the smaller brewing cylinders. The same, of course, holds true also viceversa—i.e. the machine can also be equipped with two identical brewing groups having brewing cylinders with large inner diameter. Such arrangements have the advantage that a large quantity of coffee can be obtained from the coffee machine 1 in a short time since in this case both brewing groups can produce coffee alternately nearly without interruption. Whilst coffee is being brewed with one brewing group 4 or 5, the preparation is taking place in the other brewing group 5 or 4 for the production of the next coffee beverage. The production of the coffee beverages in the coffee machine according to the invention takes place with software control and is fully automatic.

In FIG. 2 a second embodiment of the coffee machine is schematically shown. This alternative embodiment corresponds substantially to that in FIG. 1, wherein, however, the coffee dispensing outlets 6 are not routed through a non-return valve into a common coffee dispenser 11, but both coffee dispensing outlets 6 end in parallel and nearly at the same location. Thus, for example, the coffee dispenser 11 can be configured as a double pipe which is indicated in the figure as circle 8. The separate outlets have the advantage that coffee residues from a coffee dispensing outlet does not get mixed with the coffee beverage from the other dispensing outlet. If, for instance, the first brewing group 4 is preparing espresso with caffeine content and subsequently the second brewing group 5 is preparing a caffeine-free beverage, thanks to the separate coffee dispensing outlets 6, any mixing of caffeine residues with the caffeine-free beverage is avoided.

FIG. 3 shows a scheme of a third embodiment of the coffee machine 1. In this embodiment, for example, two different brewing groups 4, 5 are provided, namely the first brewing group 4 having a small brewing cylinder with a diameter, for example, of 37 mm and the second brewing group 5 having a brewing cylinder with a diameter, for example, of 44 mm. Each brewing group 4, 5 is provided with its own boiler 2, 2′. Both boilers are supplied with drinking water through the common drinking water feed pipe 9. The coffee dispensing outlets 6 of the first brewing group 4 and of the second brewing group 5 end nearly at the same location. The coffee dispenser 11 can, as shown in the previous example, also be configured as a double pipe 8 and, for example, be Y-shaped. In this way two cups 7 can be simultaneously filled.

The alternative embodiments shown in the examples can, of course, also be combined in a most varied number of ways and the coffee machine 1 according to the invention is obviously not limited to only two independently driven brewing groups 4, 5, but it is also conceivable to have more than two brewing groups 4, 5 with possibly more boilers so that one boiler 2, 2′ is allocated in each case to one or several brewing groups 4, 5, wherein the coffee machine 1 is operated, in all the alternative embodiments, fully automatically by electronic controls.

1.-5. (canceled)

6. Coffee machine with at least two brewing groups (4, 5) characterised in that the coffee machine (1) is provided with a hot water device (2, 2′), which supplies the brewing groups (4, 5) with hot water, and with a coffee dispenser (11) arranged at the same location for the brewing groups (4, 5), and in that each brewing group (4, 5) is individually actuatable.

7. Coffee machine according to claim 6, characterised in that the hot water device comprises a hot water boiler (2) which is connected to the brewing groups (4, 5) through a forked pipe and the forked pipe has a controllable valve (3) for each brewing group.

8. Coffee machine according to claim 6, characterised in that the hot water device comprises an hot water boiler (2, 2′) which is arranged individually for each brewing group (4, 5) with its own pipe is connected to the corresponding brewing group (4, 5) through a valve (3).

9. Coffee machine according to claim 6, characterised in that the coffee dispensing outlets (6) end in a common coffee dispenser (11), wherein a non-return valve (10) is provided at the opening of the coffee dispensing outlets (6).

10. Coffee machine according to claim 7, characterised in that the coffee dispensing outlets (6) end in a common coffee dispenser (11), wherein a non-return valve (10) is provided at the opening of the coffee dispensing outlets (6).

11. Coffee machine according to claim 8, characterised in that the coffee dispensing outlets (6) end in a common coffee dispenser (11), wherein a non-return valve (10) is provided at the opening of the coffee dispensing outlets (6).

12. Coffee machine according to claim 6, characterised in that for each brewing group there is provided an individual dispensing outlet (6) which ends in the coffee dispenser (11), wherein the openings of the coffee dispensing outlets (6) are arranged directly next to one another in order to dispense coffee from each brewing group (4, 5) at the same location (7).

13. Coffee machine according to claim 7, characterised in that for each brewing group there is provided an individual dispensing outlet (6) which ends in the coffee dispenser (11), wherein the openings of the coffee dispensing outlets (6) are arranged directly next to one another in order to dispense coffee from each brewing group (4, 5) at the same location (7).

14. Coffee machine according to claim 8, characterised in that for each brewing group there is provided an individual dispensing outlet (6) which ends in the coffee dispenser (11), wherein the openings of the coffee dispensing outlets (6) are arranged directly next to one another in order to dispense coffee from each brewing group (4, 5) at the same location (7).
